(19) United States
(12) Patent Application Publication
(10) Pub. No.: US 2016/0372821 A1
(43) Pub. Date: Dec. 22, 2016

(54) SEGMENTED STRUCTURE, IN PARTICULAR, FOR A SATELLITE ANTENNA REFLECTOR

(71) Applicant: AIRBUS DEFENCE AND SPACE SAS, Les Mureaux (FR)

(72) Inventors: Florian Leborgne, Montigny-le-Bretonneux (FR); Aymeric Brindeau, Nanterre (FR)

(73) Assignee: AIRBUS DEFENCE AND SPACE SAS, Les Mureaux (FR)

(21) Appl. No.: 15/100,870

(22) PCT Filed: Nov. 26, 2014
(86) PCT No.: PCT/FR2014/000254

§ 371 Date: Jun. 1, 2016

(30) Foreign Application Priority Data
Dec. 6, 2013 (FR) 13/02853

(51) Int. Cl. H01Q 1/28; H01Q 15/16

(52) U.S. Cl. CPC H01Q 1/288; H01Q 15/162

(57) ABSTRACT

A segmented structure includes a principal panel and a secondary panel, as well as at least one deployment device configured to move the secondary panel into a storage position or into a deployed position. The deployment device includes a translation system having a movable trolley, guided in translation and provided with a connection arm which is connected to the rear face of the secondary panel. The translation system is configured to generate a translation movement of said secondary panel with respect to the principal panel. The deployment device further includes a rotation system is configured to generate at least one rotation of the connection arm to generate a rotational movement of said secondary panel with respect to the principal panel.

The present invention relates to a segmented structure.

Said segmented structure comprises at least two panels which are interconnected and are to be deployed in space.

Although not exclusively, the present invention applies more specifically to a segmented structure which is part of an antenna reflector of a telecommunications satellite, in particular to a large-size antenna reflector, operating in high frequency bands. Such an antenna reflector generally has a rigid structure (referred to as a shell) which is provided with a reflective surface and reinforcing means on the rear of said surface, which are involved in supporting the shell and linking with the satellite.

The large size of the shell of such a reflector poses problems in terms of the overall dimensions when sending a satellite provided with such a reflector into space using a space booster.

In addition, for rigid reflectors which have diameters of several metres, a segmented structure is provided, which comprises a plurality of panels, in particular a three-panel structure comprising a central panel and two end panels.

Said segmented structure also comprises a device for deployment by an end panel, which is capable of transporting the end panel relative to the main panel:
either in a storage position, in which the end panel is superimposed on the main panel on the rear face of said main panel, the front face of the end panel being directed in the same direction as the front face of the main panel:
or in a deployed position in which the end panel is positioned to the side and against the main panel in order to form a continuous assembly at least on the front faces thereof.

In a segmented structure of this type, each end panel can thus occupy a storage position for transportation in the space booster, and a deployed position when the satellite is in space.

The present invention relates to a segmented structure, in particular for a satellite antenna reflector, comprising at least two panels and a deployment device which makes it possible to carry out an efficient and advantageous deployment of said two panels in space.

According to the invention, said segmented structure of the type comprising:
at least two panels, a first panel referred to as the main panel, comprising a front face and a rear face, and a second panel referred to as the secondary panel, also comprising a front face and a rear face; and
at least one deployment device which is connected to the rear faces of said main and secondary panels respectively and is capable of bringing said secondary panel into one or the other of the two following positions, relative to said main panel;
   a storage position, in which said secondary panel is superimposed at least in part on said main panel on the rear face of said main panel, the front face of said secondary panel being directed in the same direction as the front face of said main panel; and
   a deployed position in which said secondary panel is positioned towards the outside of the main panel, to the side and against said main panel in order to form a continuous assembly at least on the front faces thereof,

is notable in that said deployment device comprises:
a translation system having a movable carriage, which is guided in translation, said movable carriage being provided with a link arm which is linked to the rear face of said secondary panel, said translation system being capable of generating a translational movement of said secondary panel with respect to said main panel; and
a rotation system which is capable of generating at least one rotation of said link arm at an outer end of the translation means.

Thus, by means of the invention, the secondary panel of the segmented structure can be deployed efficiently and advantageously in space, from the storage position into the deployed position, as explained below.

Furthermore, in a preferred embodiment, said translation system comprises:
a guiding structure which is designed to guide the movable carriage in translation during a displacement; and
a drive unit which is configured to displace the movable carriage along the guiding structure.

Advantageously, said drive unit comprises:
a pulley system, comprising two pulleys which are arranged at two ends of the guiding structure, and a first rotation transmission link comprising a closed-loop link surrounding and connecting the two pulleys, said movable carriage being fixed to said first rotation transmission link; and
drive means which are configured to set into rotation a first of said two pulleys.

Preferably, said drive means comprise a rotary motor which is connected by means of a second rotation transmission link to said first pulley of the pulley system (for example via an additional pulley), in order to set said pulley into rotation.

Furthermore, advantageously:
the link arm is linked by means of a pivot link to a structural element which is rigidly connected to the rear face of the secondary panel; and/or
said guiding structure comprises a ramp-shaped structure, along which the carriage is guided, said ramp-shaped structure being fixed to the rear face of the main panel and having a height, with respect to said rear face, which decreases gradually from the inside to the outside.

Advantageously, said guiding structure comprises a guide roller which is linked to the movable carriage, said guide roller being arranged laterally in a longitudinal guide through-opening which is made in the guiding structure in order to be able to be displaced, by rotating, along said longitudinal opening.

Furthermore, in a first embodiment, said rotation system comprises:
at least one stop which is rigidly connected to the translation system at the outer end;
the link arm, a first end of which, in the region of the link to the movable carriage, is designed to come into contact with the stop, said stop and said first end being designed to cooperate in order to cause pivoting of said link arm in the region of said first end; and
drive means which are configured to set into rotation a structural element which is rigidly connected to the rear face of the secondary panel, with respect to a second end of the link arm, during the pivoting of said link arm. Preferably, said drive means comprise two pulleys which are respectively arranged at the two ends of the link arm and are interconnected by means of a third rotation transmission link.

Furthermore, in a second embodiment, said rotation system comprises an auxiliary outer end which is provided on the guiding structure, and said auxiliary outer end is curved in order to generate a rotation of the link arm which is fixed to the movable carriage during guiding of the movable carriage along said curved auxiliary outer end.

Furthermore, in a preferred embodiment, the segmented structure comprises:
a central main panel;
two secondary panels which are arranged on either side of said central main panel in the deployed position in order to have a parabolic shape; and
at least two deployment devices which are associated, respectively, with said secondary panels.

According to the envisaged variant, it is possible to provide one or more (2, 3, etc.) devices for deployment by a secondary panel.

The present invention also relates to:
a satellite antenna reflector which comprises a segmented structure of the above-mentioned type; and
a satellite which comprises at least one segmented structure of this type or one antenna reflector of this type.

The present invention also relates to a method for deploying a segmented structure of the above-mentioned type.

According to the invention, said method comprises successive steps consisting, during the deployment from the stored position into the deployed position:
a) in carrying out a translation of the movable carriage which is provided with the link arm to which said secondary panel is linked, by means of said translation system, in a translation direction towards the outside of the main panel in order to bring the movable carriage towards the outer end of the translation system; and
b) in carrying out at least one rotation of said link arm to which the secondary panel is linked, by means of said rotation system, in order to bring the secondary and main panels side by side substantially into the same general plane.

Advantageously, step b) consists in carrying out a double rotation, that is to say:
firstly, of a first end of the link arm with respect to the guiding structure which is fixed to the rear face of the main panel; and
secondly, of a structural element which is rigidly connected to the rear face of the secondary panel, with respect to a second end of the link arm.

The figures of the accompanying drawings will show how the invention can be carried out. In these figures, same reference numerals denote like elements.

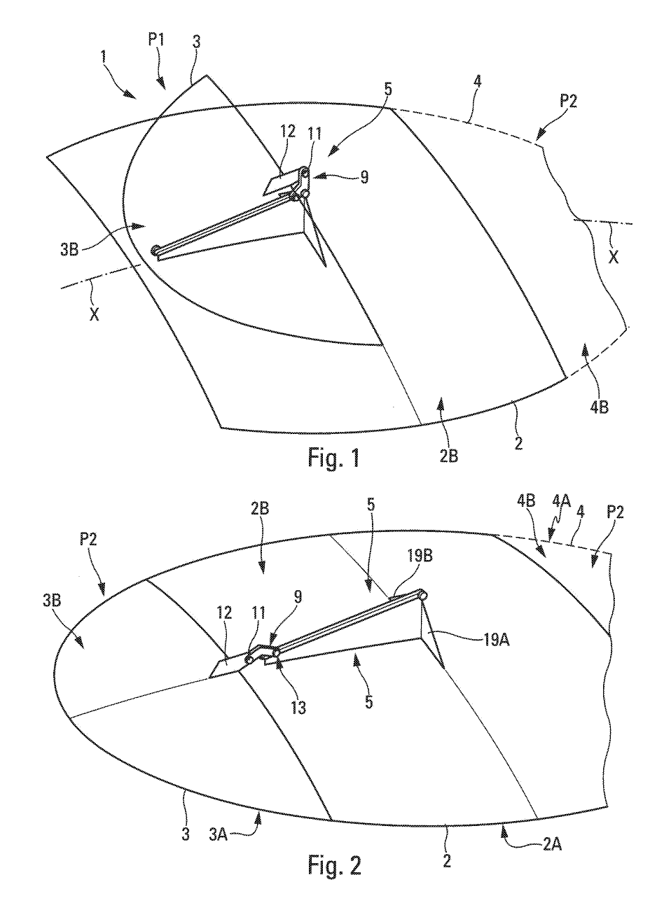

FIG. 1 is a schematic perspective view of a specific embodiment of a segmented structure illustrating the invention and comprising a central panel as well as two secondary panels, one of which is in a storage position, and the other in a deployed position.

FIG. 2 is a schematic perspective view which is similar to that in FIG. 1, but in which the two panels are in a deployed position.

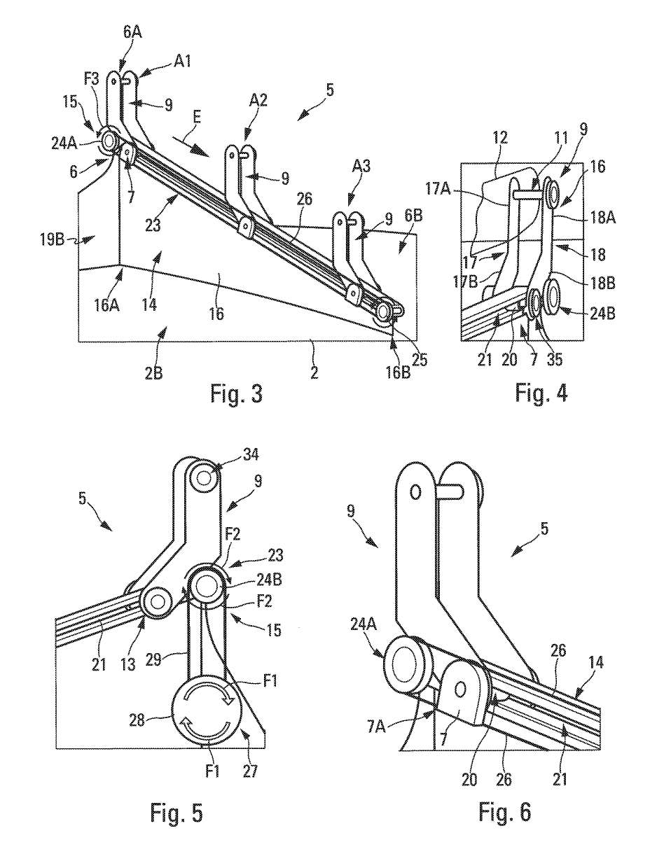

FIGS. 3 to 6 are schematic perspective partial views of a specific embodiment of a deployment device.

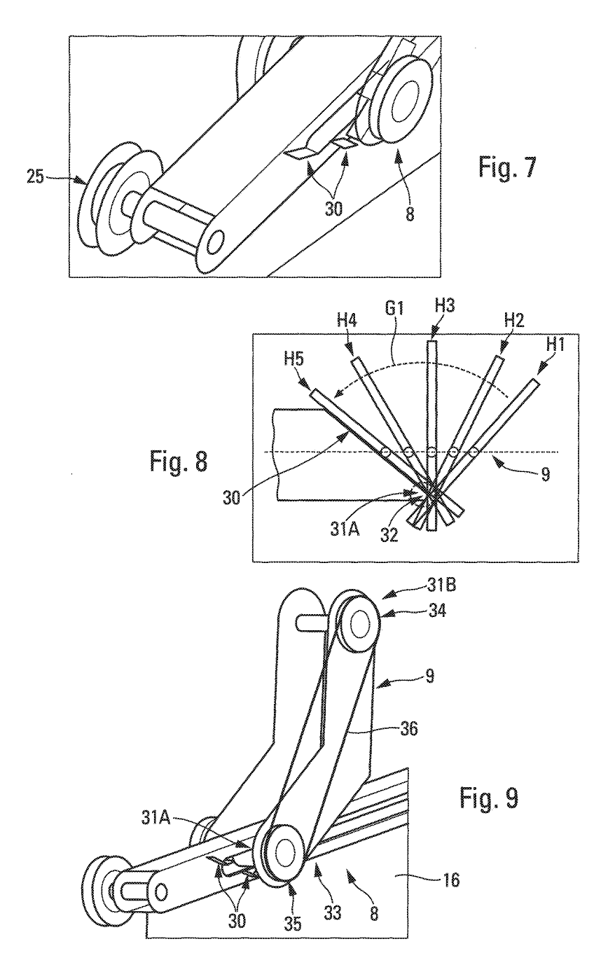

FIGS. 7 and 9 are schematic perspective partial views of a specific embodiment of a rotation system of a deployment device.

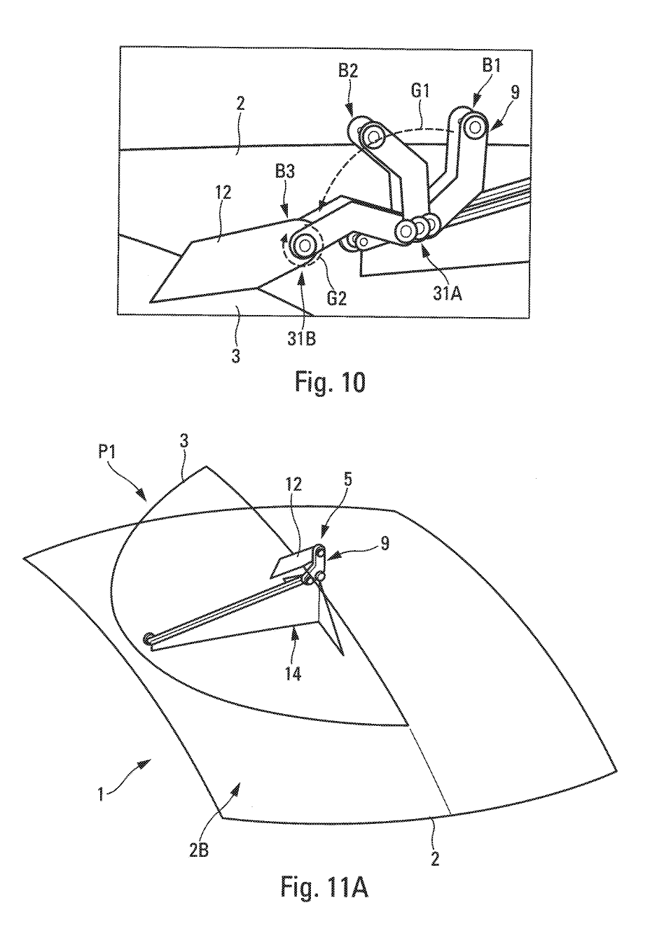

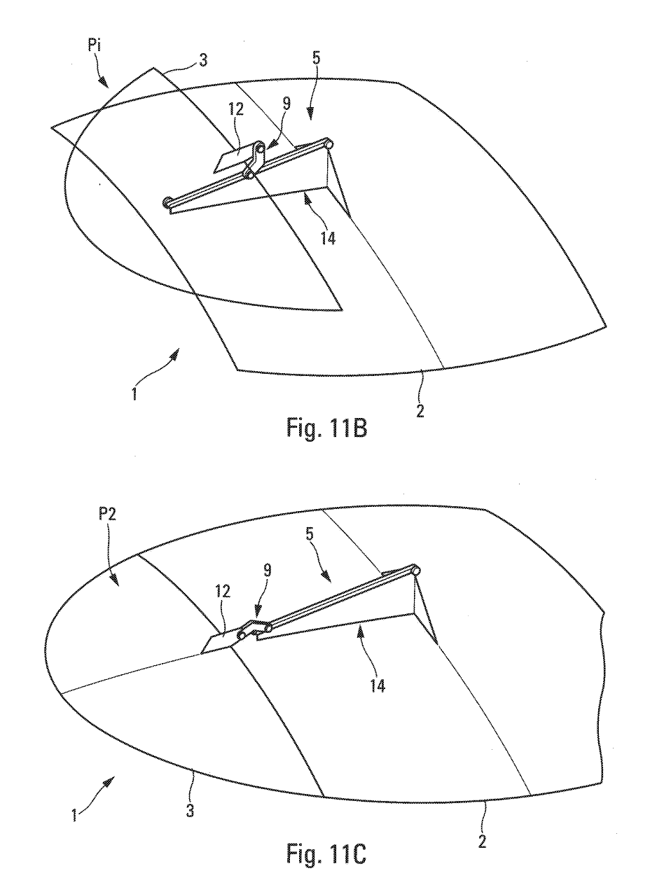

FIGS. 8 and 10 show pivoting of a link arm.

FIG. 11A to 11C show, in a schematic perspective view, different successive steps of deploying a secondary panel with respect to a main panel of a segmented structure.

The segmented structure 1, illustrating the invention and shown schematically in FIG. 1 in particular, is intended, more specifically although not exclusively, for an antenna reflector of a telecommunications satellite. Such an antenna reflector, when deployed in space, generally has a rigid structure (referred to as a shell) which is provided with a reflective surface, as well as reinforcing and support means (not shown) on the rear of said structure, which are involved in supporting the shell and linking with the satellite. In particular for reasons relating to the overall dimensions during the launch of the satellite by a space booster, said structure is of the segmented type, i.e. it is formed of a plurality of segments or panels.

More specifically, the present invention relates to a segmented structure 1 of the type comprising:
at least two panels, that is to say at least a first panel 2 referred to as the main panel, comprising a front face 2A and a rear face 2B (FIGS. 1 and 2), and at least a second panel 3, 4 referred to as the secondary panel, also comprising a front face 3A, 4A and a rear face 3B, 4B; and
at least one deployment device 5 which is connected to the rear faces 2B and 3B respectively of the main panel 2 and of a secondary panel (the panel 3 in the example in FIGS. 1 and 2).

Said deployment device 5 is capable of bringing the secondary panel 3 into one or the other of the two following positions, relative to the main panel 2:
a storage position P1 as shown in FIGS. 1 and 11A, in which said secondary panel 3 is superimposed at least in part, and preferably is completely superimposed on the main panel 2 on the main face 2B of said main panel. The front face 3A of the secondary panel 3 is directed in the same direction as the front face 2A of the main panel 2; and
a deployed position P2 as shown in FIGS. 2 and 11C, in which the secondary panel 3 is positioned to the side and against the main panel 2 in order to form a continuous assembly at least on the front faces 2A and 3A thereof.

In the description of the present invention:
front face and rear face are understood to mean the two faces of a panel, the front face 3A, 4A of a secondary panel 3, 4 being superimposed at least in part on the rear face 2B of the main panel 2, each front face 2A, 3A, 4A corresponding in the case of an antenna reflector to the reflective face; and
inner and outer are understood to mean the positions of the different elements in question with respect to the centre of the segmented structure 1 in the deployed position of said structure (FIG. 2), “inner” applying to the position closest to the centre, and “outer” applying to the position furthest away from the centre in said deployed position (in the direction of an axis X-X (FIG. 1), in the case of a symmetry axis of the segmented structure 1).

In the preferred embodiment, which is shown in the drawings, the segmented structure 1 comprises:
a central main panel 2;
two secondary panels 3 and 4 which are arranged on either side of said central main panel 2 in the fully deployed position (FIG. 2) in such a way that these three panels 2, 3 and 4 have a parabolic shape in said fully deployed position; and
two deployment devices 5 which are associated, respectively, with said secondary panels 3 and 4, of which only the device which is associated with the secondary panel 3 is shown.

According to the envisaged variant, it is possible to provide one or more (2, 3, etc.) devices for deployment 5 by a secondary panel 3, 4.

In the situation in FIG. 1 one 4 of the secondary panels 3 and 4 is in the deployed position P2, and the other 3 of said secondary panels 3 and 4 is in the storage position P1. In order to simplify the drawings, the deployment device of the deployed secondary panel 4 (which is similar to that 5 of the secondary panel 3) is not shown in FIG. 1, and the secondary panel 4 is only shown in part as dashed lines.

According to the invention, each of the deployment devices 5 of the segmented structure 1 comprises:
a translation system 6 comprising a movable carriage 7, which is guided in translation from an inner end 6A to an outer end 6B. The movable carriage 7 is provided with a link arm 9 which is linked to the rear face 3B, 4B of said secondary panel 3, 4. Said translation system 6 is capable of generating a translational movement of said secondary panel 3, 4 with respect to said main panel 2, as shown by three successive positions A1, A2 and A3 of the link arm 9 in FIG. 3; and
a rotation system 8 which is capable of generating at least one rotation of said link arm 9 at an outer end 6B (FIG. 3) of the translation system 6, in order to generate a rotational movement of said secondary panel 3, 4 with respect to said main panel 2.

The link arm 9 is linked:
by means of a pivot link 11 to a structural element 12 which is rigidly connected to the rear face 3B of the secondary panel 3, as shown in FIGS. 1 and 2: and
by means of a pivot link 13 to the movable carriage 7, as shown in FIGS. 2 and 5.

A deployment device 5 of this type (comprising an assembly of a pivoting system and a link arm, supported by a carriage which is movable in translation) makes it possible to carry out an efficient and advantageous deployment of the secondary panel 3, 4, with which it is associated, from the storage position P1 into the deployed position P2, as explained below.

Said translation system 6 comprises, as shown in FIG. 3:
a guiding structure 14 which is designed to guide the movable carriage 7 in translation during a displacement in the direction indicated by an arrow E; and
a drive unit 15 which is configured to displace the movable carriage 7 along the guiding structure 14.

Said guiding structure 14 comprises a structure 16 which is in the form of a plate and is ramp-shaped. Said structure 16 is fixed to the rear face 2B of the main panel 2 and has a height, with respect to said rear face 2B, which decreases gradually from the inside to the outside, i.e. from an inner end 16A to an outer end 16B of the structure 16 (FIG. 3).

The guiding structure 14 also comprises, in the region of the inner end 16A of the structure 16, two transverse planar elements 19A and 19B which are intended to laterally support the structure 16, as shown for example in FIGS. 2 and 3.

Preferably, the two transverse planar elements 19A and 19B are part of means for reinforcing the segmented structure 1, such as those provided on the rear of the reflective surface in the case of an antenna reflector.

Furthermore, in a specific embodiment, as shown in particular in FIG. 4, the link arm 9 comprises two arm portions 17 and 18, which have a planar shape, are identical, and are arranged in parallel with one another. Each of said arm portions 17 and 18 comprises two elongate planar segments, which are upper 17A, 18A and lower 17B, 18B respectively, which are interconnected to form an elbow. The pivot link 11 is provided at the (upper) free end between the two upper segments 17A and 18A. The structural element 12 which is arranged between these two segments 17A and 18A is shown in part and transparently in FIG. 4. In addition, the link arm 9 is linked to the movable carriage 7 by a pivot link by means of the (lower) free end of the two lower segments 17B and 18B.

Said guiding structure 14 also comprises a guide roller 20 which is linked to the movable carriage 7 (FIGS. 4 and 6). The guide roller 20 is arranged laterally in a longitudinal guide through-opening 21 which is made in the guiding structure 14 in order to be able to be displaced, by rotating, along said longitudinal opening 21.

Furthermore, said drive unit 15 comprises:
a pulley system 23; comprising two pulleys 24A and 25 which are arranged at two ends of the guiding structure 14, and a rotation transmission link 26 comprising a closed-loop link (preferably a cable) surrounding and connecting the two pulleys 24A and 25, as shown in particular in FIG. 3. Said carriage 7 is fixed to said rotation transmission link 26 at an end 7A (FIG. 6); and
drive means 27 which are configured to set into rotation a first 24A of said two pulleys 24A and 25 of the pulley system 23, as shown in FIGS. 3 and 5.

Said drive means 27 comprise a conventional rotary motor 28, shown schematically in FIG. 5, which is connected by means of a rotation transmission link 29 (preferably a cable) to a pulley 24B which is connected to the pulley 24A of the pulley system 23, in order to set said pulley into rotation, as shown by arrows F2. Thus, when the rotary motor 28, preferably an electric motor, generates a rotation shown by arrows F1 in FIG. 5, the pulley 24B is set into rotation as shown by arrows F2. Said pulley thus sets into rotation the pulley 24A (arrows F3 in FIG. 3) which displaces the carriage 7 and the link arm 9 (via the link 26) in the direction E (FIG. 3). The motor 28 allows speed control and a rotation direction for a reversible deployment.

Furthermore, the rotation system 8 (which is capable of generating the rotation of the translation system 6) can be produced in various ways.

In a first preferred embodiment, which is shown in FIGS. 7 to 10, said rotation system 8 comprises:
at least one stop 30 which is rigidly connected to the trans a ion system 6 and the guiding structure 14 at the outer end 6B;
the link arm 9, one end 31A of which, in the region of the link to the carriage 7, is designed to come into contact with the stop 30. The stop 30 and said end 31A are designed to cooperate in order to cause pivoting of the link arm 9 in the region of said first end 31A about a point of contact 32, as shown by different positions H1 to H5 in FIG. 8; and
drive means 33 which are configured to set into rotation the structural element 12 which is rigidly connected to the rear face 3B of the secondary panel 3, with respect to a second end 31B of the link arm 9, during the pivoting of said link arm 9.

In the embodiment shown in FIG. 9, said drive means 33 comprise two pulleys 34 and 35 which are respectively arranged at the two ends of the link arm 9 and are interconnected by a rotation transmission link 36 (preferably a cable).

The pulley 35 is set into rotation by the abutment and the translation. and transmits the rotational movement to the pulley 34, causing the pivoting of the structural element 12 in the direction of an arrow G2 (during the pivoting of the link arm in the direction of an arrow G1), as shown in FIG. 10. FIG. 10 shows different successive positions B1, B2 and B3 during the pivoting in order to end in the position B3 which makes it possible to position the secondary panel 3 in the general plane of the main panel 2.

Furthermore, in a second embodiment (not shown), said rotation system can comprise an auxiliary outer end which is provided on the guiding structure. Said auxiliary outer end is curved in order to generate a rotation of the link arm which is fixed to the carriage during guiding of the carriage along said curved auxiliary outer end.

The deployment devices 5 of the segmented structure 1, which are associated with the different secondary panels 3 and 4 of said segmented structure 1, thus make it possible to carry out a deployment of the segmented structure 1 from a complete storage position (in which all the secondary panels 3 and 4 are in a storage position P1) to a fully deployed position (in which all the secondary panels 3 and 4 are in a deployed position P2, as shown in particular in FIG. 2).

The deployment device 5 also comprises means which are not shown (for example a central unit) for controlling, in particular, the rotary motor 28 (electric motor).

Furthermore, the segmented structure 1 can comprise conventional means (not shown) for supporting the different panels 2, 3 and 4 in the storage position P1. Said support means are released before deployment so that each deployment device 5 can implement the deployment explained below.

The operation of said deployment device 5, for the deployment of one 3 of said secondary panels 3, 4 from the stored position P1 in FIGS. 1 and 11A into the deployed position P2 in FIGS. 2 and 11C, is as follows:
a) from the stored position P1 in FIG. 11A for example, a translation is carried out of the movable carriage 7 which is provided with the link arm 9 to which said secondary panel 3 is linked, by means of said translation system 6, in a translation direction E towards the outside in order to bring the movable carriage 7 towards the outer end 6B of the translation system 6. FIG. 11A to 11C show different successive steps of the deployment of the secondary panel 3 with respect to the main panel 2, FIG. 11B showing an intermediate position Pi between the positions P1 and P2; and
b) at least one rotation is carried out of said link arm 9, to which the secondary panel 3 is linked, by means of said rotation system 8, in order to bring the secondary panel 3 substantially into the general plane of the main panel 2, by also bringing the secondary panel 3 substantially into contact with the main panel 2, in a position that is the deployed position P2, as shown in FIG. 11C.

Step b) consists in carrying out a double rotation, as shown in FIG. 10, that is to say:
firstly, of a first end 31A of the link arm 9 with respect to the guiding structure 14 which is fixed to the rear face 2B of the main panel 2, as shown by the arrow G1; and
secondly, of a structural element 12 which is rigidly connected to the rear face 38 of the secondary panel 3, with respect to a second end 31B of the link arm 9, as shown by the arrow G2.

The same deployment method is implemented for the secondary panel 4 (not shown in FIG. 11A to 11C) in order to eventually obtain a fully deployed position of the segmented structure 1.

Of course, the device 5 can also bring the segmented structure from the deployed position P2 into the stored position P1, should that become necessary, for example for a validation operation, by carrying out the above-mentioned operations in reverse order (b, a), with each operation (rotation, translation) being implemented in the opposite direction.

Furthermore, the segmented structure 1 can comprise means (not shown) for allowing a precise final positioning between a secondary panel 3, 4 and the main panel 2, for example in the situation in FIG. 11C for the secondary panel 3, as well as means for locking the panels in the fully deployed position of the segmented structure 1.

1. Segmented structure, in particular for a satellite antenna reflector, said segmented structure comprising:
a main panel, comprising a front face and a rear face, and a secondary panel, also comprising a front face, and a rear face; and
at least one deployment device which is connected to the rear faces of said main and secondary panels respectively and is configured to bring said secondary panel into one or the other of the two following positions, relative to said main panel;
a storage position, in which said secondary panel is superimposed at least in part on said main panel on the rear face of said main panel, the front face of said secondary panel being directed in the same direction as the front face of said main panel; and
a deployed position in which said secondary panel is positioned towards the outside of the main panel, to the side and against said main panel in order to form a continuous assembly at least on the front faces thereof,
wherein said deployment device comprises:
a translation system having a movable carriage, which is guided in translation, said movable carriage being provided with a link arm which is linked to the rear face of said secondary panel, said translation system being configured to generate a translational movement of said secondary panel with respect to said main panel; and
a rotation system configured to generate at least one rotation of said link arm at an outer end of the translation system, in order to generate a rotational movement of said secondary panel with respect to said main panel.

2. Segmented structure according to claim 1, wherein said translation system comprises:
a guiding structure which is configured to guide the movable carriage in translation during a displacement; and
a drive unit which is configured to displace the movable carriage along the guiding structure.

3. Segmented structure according to claim 2, wherein said drive unit comprises:
a pulley system; comprising two pulleys which are arranged at two ends of the guiding structure, and a first rotation transmission link comprising a closed-loop link surrounding and connecting the two pulleys, said movable carriage being fixed to said first rotation transmission link; and
drive means which are configured to set into rotation a first of said two pulleys.

4. Segmented structure according to claim 3, wherein said drive means comprise a rotary motor which is connected by means of a second rotation transmission link to said first pulley of the pulley system, in order to set said pulley into rotation.

5. Segmented structure according to claim 1, wherein the link arm is linked by means of a pivot link to a structural element which is rigidly connected to the rear face of the secondary panel.

6. Segmented structure according to claim 2, wherein said guiding structure comprises a ramp-shaped structure, along which the movable carriage is guided, said ramp-shaped structure being fixed to the rear face of the main panel and having a height, with respect to said rear face, which decreases gradually from the inside to the outside of the main panel.

7. Segmented structure according to claim 2, wherein said guiding structure comprises a guide roller which is linked to the movable carriage, said guide roller being arranged laterally in a longitudinal guide through-opening which is made in the guiding structure in order to be able to be displaced, by rotating, along said longitudinal opening.

8. Segmented structure according to claim 1, wherein said rotation system comprises:
at least one stop which is rigidly connected to the translation system at the outer end;
the link arm, a first end of which, in the region of the link to the movable carriage, is designed to come into contact with the stop, said stop
and said first end being configured to cooperate in order to cause pivoting of said link arm in the region of said first end; and
drive means which are configured to set into rotation a structural element which is rigidly connected to the rear face of the secondary panel, with respect to a second end of the link arm, during the pivoting of said link arm.

9. Segmented structure according to claim 7, wherein the drive means comprise two pulleys which are respectively arranged at the two ends of the link arm and are interconnected by means of a third rotation transmission link.

10. Segmented structure according to claim 1, wherein the rotation system comprises an auxiliary outer end which is provided on the guiding structure, and in that said auxiliary outer end is curved in order to generate a rotation of the link arm which is fixed to the movable carriage during guiding of the movable carriage along said curved auxiliary outer end.

11. Segmented structure according to claim 1, comprising:
a central main panel;
two secondary panels which are arranged on either side of said central main panel in the deployed position in order to have a parabolic shape; and
at least two deployment devices which are associated, respectively, with said secondary panels.

12. Satellite antenna reflector, comprising a segmented structure according to claim 1.

13. Satellite, comprising at least one segmented structure according to claim 1.

14. Method for deploying a segmented structure according to claim 1, comprising successive steps consisting, during the deployment from the stored position into the deployed position:
a) in carrying out a translation of the movable carriage which is provided with the link arm to which said secondary panel is linked, by said translation system in a translation direction towards the outside of the main panel in order to bring the movable carriage towards the outer end of the translation system; and
b) in carrying out at least one rotation of said link arm to which the secondary panel is linked, by means of said rotation system, in order to bring the secondary and main panels side by side substantially into the same general plane.

15. Method for deploying according to claim 14, wherein step b) comprises carrying out a double rotation, wherein:
firstly, of a first end of the link arm with respect to the guiding structure which is fixed to the rear face of the main panel; and
secondly, of a structural element which is rigidly connected to the rear face of the secondary panel, with respect to a second end of the link arm.
